(19) United States
(12) Patent Application Publication
(10) Pub. No.: US 2013/0285957 A1
(43) Pub. Date: Oct. 31, 2013

(54) DISPLAY DEVICE AND METHOD USING A PLURALITY OF DISPLAY PANELS

(71) Applicant: SAMSUNG ELECTRONICS CO., LTD., Gyeonggi-do (KR)

(72) Inventors: Po-Ra KIM, Seoul (KR); Jeong-Seok Lee, Gyeonggi-do (KR); In-Kuk Yun, Gyeonggi-do (KR)

(73) Assignee: Samsung Electronics Co., Ltd., Gyeonggi-do (KR)

(21) Appl. No.: 13/871,567

(22) Filed: Apr. 26, 2013

(30) Foreign Application Priority Data
Apr. 26, 2012 (KR) 10-2012-0043812

(51) Int. Cl. G06F 3/041

(52) U.S. Cl. CPC G06F 3/0414
USPC 345/173

(57) ABSTRACT

A display device including a plurality of display panels and one or more vibration sensors for detecting a vibration by a touch of an input device. The vibration sensors are attached to the plurality of display panels The display device also includes a controller for, when one of the plurality of display panels is touched by the input device, identifying the display panel touched by the input device from the plurality of display panels according to vibration intensities detected by one or more vibration sensors. A display panel on which an input by an electronic pen is performed among multiple display panels can be identified through vibration intensities, so that input position detection using pattern recognition can be achieved even when the plurality of display panels are used.

### PRIORITY

This application claims priority under 35 U.S.C. §119(a) to Korean Application Serial No. 10-2012-0043812, which was filed in the Korean Intellectual Property Office on Apr. 26, 2012, the entire content of which is incorporated herein by reference.

### BACKGROUND OF THE INVENTION

1. Field of the Invention

The present invention relates generally to a display device, and more particularly, to a display device and method using a plurality of display panels.

2. Description of the Related Art

With the recent developments in display technologies, display devices provide an input function for recognizing a position of a finger or a pen on a screen and performing an input according to the position as well as a display function of simply displaying an image on the screen.

One example of the input function of the display device is a function for sensing a position of a finger or pen on a display screen according to a technique using a pattern recognition and performing an input according to the position. More specifically, this technique photographs a pattern formed in a display panel using an input device including a camera, such as an electronic pen, which recognizes the pattern from the photographed image to detect a position of the electronic pen corresponding to the pattern, and performs an input through a detected position value. The input technique using the pattern recognition is used for an electronic bulletin board and the like to be electronically readable, and thus is widely used in various fields.

However, the method using pattern recognition utilizes a pattern formed on a single display panel. Therefore, it is limited in that only a coordinate value within the single display panel can be detected.

As a screen size of the display device becomes larger, demands for large sized display panels also increase. However, as the size of the display panel becomes larger, costs increase, so that a plurality of display panels generated by combining a plurality of single display panels are used in most cases. With the pattern recognition technique, the display device can detect a position within each of the plurality of display panels, but cannot detect the display panel into which the pattern is input among the plurality of display panels.

Accordingly, the display device including the plurality of display panels is precluded from using the pattern recognition technique.

### SUMMARY OF THE INVENTION

The present invention has been made to address at least the problems and disadvantages described above, and to provide at least the advantages described below. Accordingly, aspects of the present invention provide a display device and method using a plurality of display panels which can detect an input position through the pattern recognition technique even when the plurality of display panels are used.

Another aspect of the present invention is to provide a display device and method using a plurality of display panels which can detect a panel change even when an input position is moved from a first display panel into a second display panel in the display device using the plurality of display panels.

In accordance with an aspect of the present invention, a display device including a plurality of display panels is provided. The display device includes a plurality of display panels; one or more vibration sensors for detecting a vibration by a touch of an input device, the vibration sensors being attached to the plurality of display panels; and a controller for, when one of the plurality of display panels is touched by the input device, selecting the display panel touched by the input device from the plurality of display panels according to vibration intensities detected by the one or more vibrations sensors.

In accordance with another aspect of the present invention, a display method including a plurality of display panels is provided. The display method includes detecting whether an input device touches one of a plurality of display panels; receiving vibration intensities detected by one or more vibration sensors when the input device touches one of the plurality of display panels; and selecting the display panel touched by the input device from the plurality of display panels according to the received vibration intensities.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram illustrating a pattern formed in one of a plurality of display panels according to an embodiment of the present invention;

FIG. 2 is a diagram illustrating a display device including a plurality of lay panels according to an embodiment of the present invention;

FIG. 3 is a diagram illustrating a display device including a plurality of display panels according to a first embodiment of the present invention;

FIG. 4 a diagram illustrating a configuration of the display device including the plurality of display panels according to the first embodiment of the present invention;

FIGS. 5A and 5B are flowcharts illustrating a method for using, by the display device, the plurality of panels according to the first embodiment of the present invention;

FIG. 6 is a diagram illustrating a display device including a plurality display panels according to a second embodiment of the present invention;

FIG. 7 is a diagram illustrating a configuration of the display device including the plurality of display panels according to the second embodiment of the present invention; and

FIGS. 8A and 8B are flowcharts of operations of the display device including the plurality of display panels according to the second embodiment of the present invention.

### DETAILED DESCRIPTION OF EMBODIMENTS OF THE PRESENT INVENTION

Hereinafter, various embodiments of the present invention will be described with reference to the accompanying drawings. In the following description, the same elements will be designated by the same reference numerals although they are shown in different drawings. Further, various specific definitions found in the following description are provided only to help general understanding of the present invention, and it is apparent to those skilled in the art that the present invention can be implemented without such definitions. Further, in the following description of the present invention, a detailed description of known functions and configurations incorporated herein will be omitted when it may obscure the subject matter of the present invention.

The present invention discloses a display device and method using a plurality of display panels in which an input into one of the plurality of display panels by means of an input device (hereinafter, referred to as an “electronic pen”) is detected using a pattern recognition technique. Particularly, when an input by the electronic pen is performed, the display device, which includes the plurality of display panels, selects a display panel in which the input is performed according to a vibration intensity detected by one or more vibration sensors and calculates a position of the input on the selected display panel. Further, when a coordinate at which the electronic pen is located is changed by a drawing operation of a user, the display device selects a display panel in which the electronic pen is located by using a change of the coordinate (for example, x coordinate) value.

In the embodiment of the present invention, the plurality of display panels may include any display panel having a pattern, such as, for example, a Liquid Crystal Display (LCD), a Plasma Display Panel (PDP), an Organic Light-Emitting Display (OLED), an electronic paper and the like.

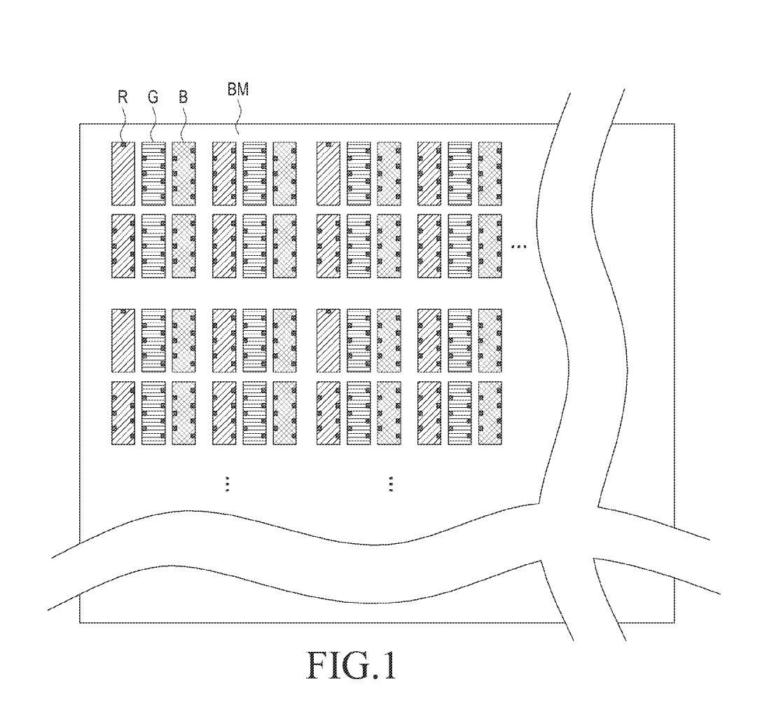

FIG. 1 is a diagram illustrating a pattern formed in one of plurality of display panels according to an embodiment of the present invention. FIG. 1 shows a display panel in which the pattern is formed to determine a position of a pixel by using sub pixels R, G, and B and Black Matrix (BM). Referring to FIG. 1, each of the sub pixels R, G, and B includes one or a plurality of holes in specific internal positions according to a predetermined pattern type in order to determine the position of the pixel. In this embodiment, the holes are formed in such a manner that black matrix regions are brought within and included in an area of each of the sub pixels R, G, and B, and the holes can be formed by the same materials as those of the black matrix regions. The holes may include other materials which can be recognized as the pattern in the R, G, and B areas and disposed in other positions.

As illustrated in FIG. 1, the pattern formed in the display panel is photographed by the electronic pen. The pattern is recognized from the photographed image, and then an input position of the electronic pen on the display panel is calculated. Since the pattern can be used to calculate only the position on the corresponding display panel, the display device calculates the position of the display panel among the multiple display panels by using vibration intensities or a change of the coordinate value where the electronic pen is located.

The following description addresses a case in which the display device includes a plurality of display panels having the pattern formed therein as illustrated in FIG. 1.

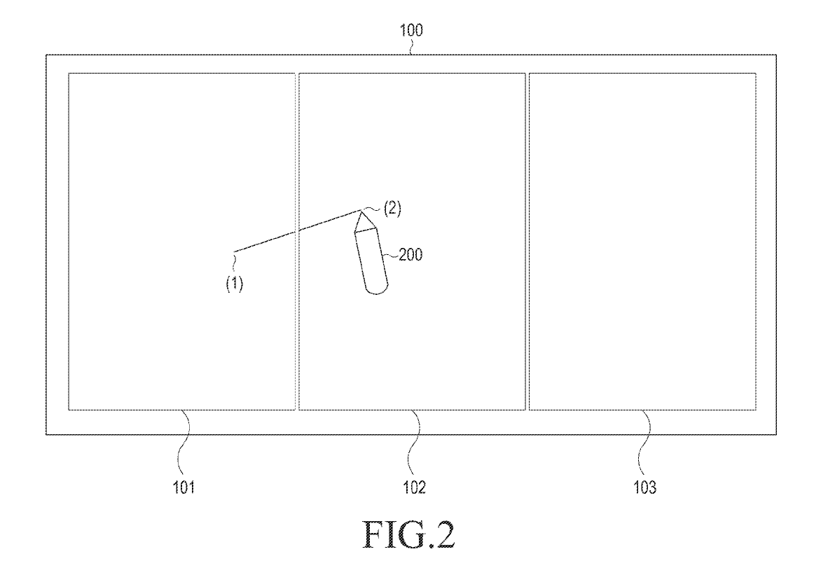

FIG. 2 is a diagram illustrating the display device including the plurality of display panels according to an embodiment of the present invention. Referring to FIG. 1, the display device 100 includes multiple display panels generated by connecting three display panels including a first display panel 101, a second display panel 102, a third display panel 103.

When an electronic pen 200 touches the first display panel 101 to perform an input such as “-,” the display device 100 detects a vibration intensity by the touch of the electronic pen 200 using one or more vibration sensors. Further, the display device 100 selects the first display panel 101 touched by the electronic pen 200 from the first to third display panels 101 to 103 according to the detected vibration intensity. In addition, the display device 100 detects a first position value corresponding to a first input position 1 of the electronic pen 200 on the selected first display panel 101 by using a coordinate value received from the electronic pen 200.

Further, when the electronic pen 200 moves to a second input position 2, according to a drawing action of the user while touching the first input position, the display device 100 selects a display panel in which the electronic pen 200 is located by using a change in the coordinate value on a trace along which the electronic pen 200 has moved. For example, in a case where the first to third display panels 101 to 103 have position values within a range from (0, 0) to (1080, 1920), when a change in the X coordinate value of the electronic pen 200 is equal to or larger than a predetermined value of, for example, 1000, the display device 100 selects the second display panel 102 because the electronic pen 200 is moved to and located in the second display panel 102 in an X direction. Further, the display device 100 detects a second position value corresponding to the second input position 2 of the electronic pen 200 on the selected second display panel 102 by using a coordinate value received from the electronic pen 200.

As described above, the display device 100 detects which display panel is touched by the electronic pen 200 among the plurality of display panels 101 to 103 according to the vibration intensity generated as the electronic pen 200 touches the display panel. Further, the display device 100 detects which display panel has the changed input position, even when the input position of the electronic pen 200 is moved from one display panel to another display panel.

A configuration of the display device including the plurality of display panels according to the embodiment of the present invention as described above will now be described in more detail.

The display device can be implemented to include various configurations depending on the number display panels, the number of vibration sensors, and a position of the vibration sensor on the display panel.

According to a first embodiment of the present invention, the display device includes a plurality of display panels formed by connecting three display panels, a center display panel having two vibration sensors. According to a second embodiment of the present invention, the display device includes a plurality of display panels formed by connecting three display panels, each of which includes a vibration sensor.

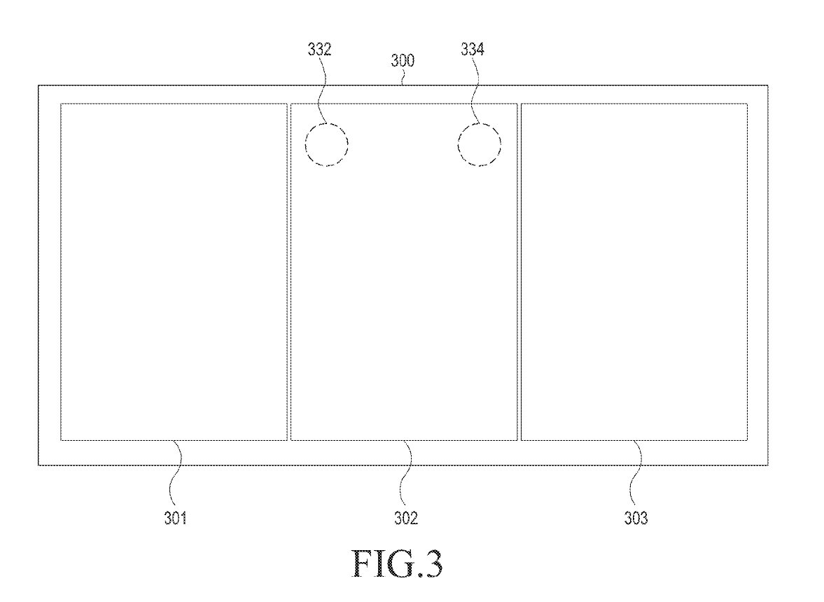

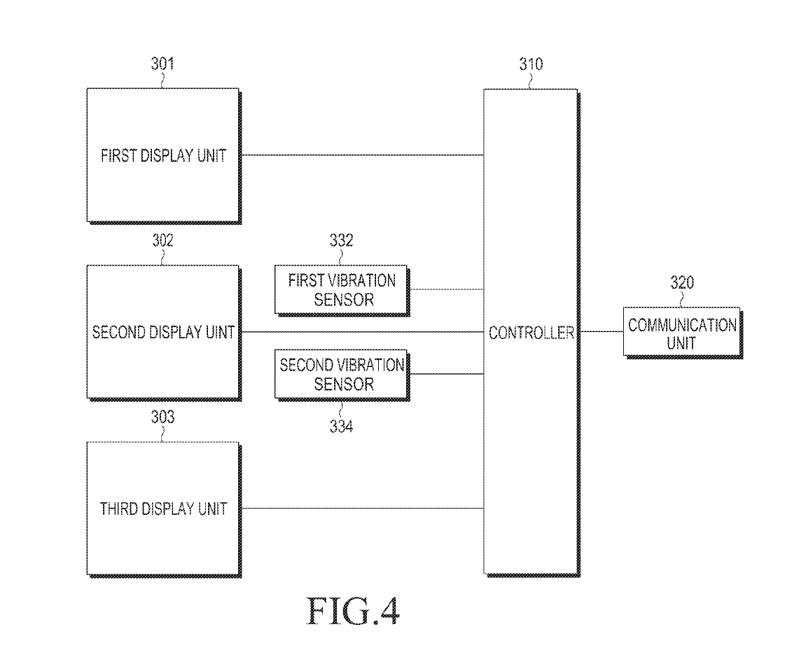

First, the display device using according to the first embodiment of the present invention will be described. FIG. 3 is a diagram illustrating the display device 300 including the plurality of display panels according to the first embodiment of the present invention. FIG. 4 is a diagram illustrating a configuration of the display device 300.

Referring to FIG. 3, the display device 300 according to the first embodiment of the present invention includes a plurality of display panels formed by connecting three display panels 301, 302, and 303. Two vibration sensors 332 and 334 may be attached to a rear surface of the second display panel 302 which is at a center of the three display panels 301, 302, and 303.

Further, referring to FIG. 4, the display device 300 according to the first embodiment includes the first display panel 301, the second display panel 302, the third display panel 303, the first vibration sensor 332, the second vibration sensor 334, a controller 310, and a communication unit 320.

Each of the first display panel 301, the second display panel 302, and the third display panel 303 includes a pattern as illustrated in FIG. 1, detects a touch of the electronic pen 200 according to a frequency characteristic generated by the touch of the electronic pen 200, and transmits the detection to the controller 310.

The first vibration sensor 332 and the second vibration sensor 334 are attached to upper left and right sides of the rear surface of the second display panel 302, which corresponds to the center display panel. The first vibration sensor 332 and the second vibration sensor 334 detect a vibration generated as the electronic pen 200 touches one of the first to third display panels 301 to 303 and transmits an intensity of the detected vibration to the controller 310.

The controller 310 receives a signal corresponding to a presence of the touch of the electronic pen 200 from one of the first to third display panels 301 to 303 and determines the existence or nonexistence of the touch of the electronic pen 200. When the electronic pen 200 touches the display panel, the controller 310 selects the display panel touched by the electronic pen 200 from the first to third display panels 301 to 303 according to the vibration intensities received from the first vibration sensor 332 and the second vibration sensor 334. Further, the controller 310 calculates an input position on the selected display panel by using a coordinate value of the electronic pen 200 received through the communication unit 320. In addition, when an input position changes according to a drawing action of the user while the electronic pen 200 is touching, the controller 200 selects the display panel in which the electronic pen 200 is located after the input position change by using a change in the coordinate value (x coordinate) on a trace along which the electronic pen 200 has moved.

The communication unit 320 may be implemented by, for example, a ZigBee module and the like, and receives a coordinate value from the electronic pen 200. At this time, when an input is performed as the electronic pen 200 touches or approaches one of the first to third display panels 301 to 303, the electronic pen 200 photographs a pattern formed in a corresponding input position, recognizes the pattern from the photographed pattern image, and calculates a corresponding coordinate value. Subsequently, the electronic pen 200 transmits the calculated coordinate value to the display device 300.

An operation of the display device 300 according to the first embodiment of the present invention as described above will now be described.

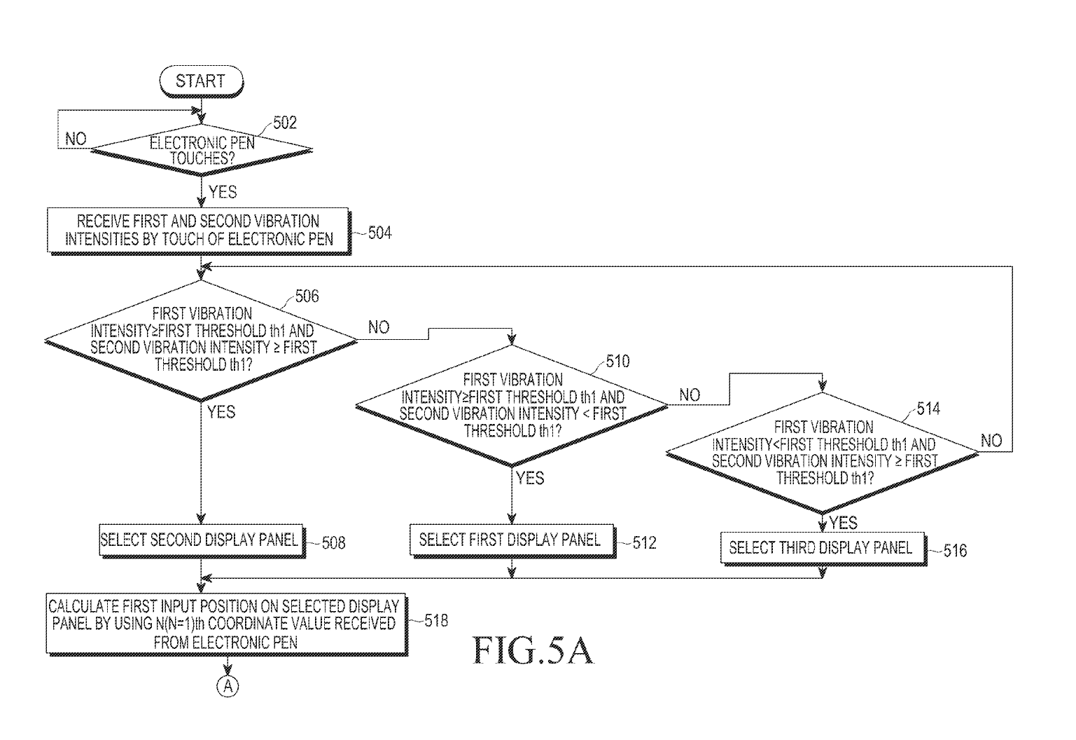

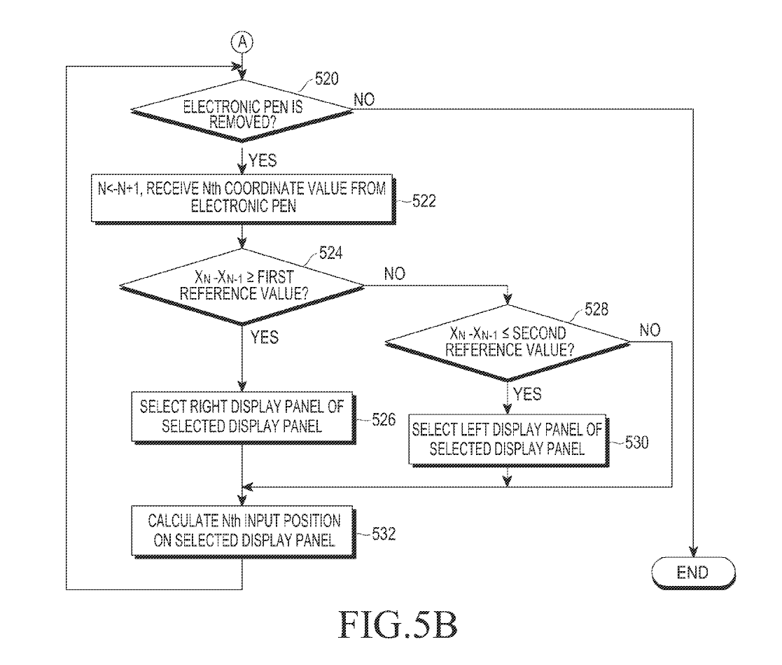

FIGS. 5A and 5B are flowcharts illustrating operations of the display device 300 including the plurality of display panels according to the first embodiment of the present invention. Referring to FIG. 5A, in step 502, the controller 310 of the display device 300 determines whether the electronic pen 200 touches the first to third display panels 301 to 303.

Each of the first to third display panels 301 to 303 detects existence or nonexistence of the touch of the electronic pen 200 according to a frequency characteristic generated according to the touch of the electronic pen 200 and transmits a signal corresponding to the detection to the controller 310. The controller 310 receives the signal corresponding to the existence or nonexistence of the touch of the electronic pen 200 from the first to third display panels 301 to 303 and determines the existence or nonexistence of the touch of the electronic pen 200. Here, each of the first to third display panels 301 to 303 detects the frequency generated by a touch of an object. When the measured frequency corresponds to a frequency band corresponding to the touch of the electronic pen 200, each of the first to third display panels 301 to 303 detects the touch of the electronic pen 200. Further, when the electronic pen 200 touches the display panel, the frequency band corresponding to the touch of the electronic pen 200 can be predetermined by using a characteristic in which an inherent frequency by the electronic pen 200 is generated. In general, when a finger touches the display panel, a low frequency is generated. When a hard object touches the display panel, a high frequency is generated. In the embodiment of the present invention, the frequency band generated when a pen tip of the electronic pen 200 touches the display panel is predetermined, and it is determined that the electronic pen 200 touches the display panel when the measured frequency corresponds to the predetermined frequency band.

When the electronic pen 200 touches the first to third display panels 301 to 303, the controller 310 receives first and second vibration intensities corresponding to vibrations generated by the touch of the electronic pen 200 from the first and second vibration sensors 332 and 334 in step 504. At this time, the first vibration sensor 332 and the second vibration sensor 334 detect the vibration generated as the electronic pen 200 touches one of the first to third display panels 301 to 303 and transmits first and second vibration intensities of the detected vibration to the controller 310. Since the first and second vibration intensities measured from the first and second vibration sensors 332 and 334 are inversely proportional to a distance between a position (starting place) where the electronic pen 200 touches the display panel and each of the first and second vibrations sensors 332 and 334, it is possible to determine which display panel was touched by the electronic pen 200 using the first and second vibration intensities.

In step 506, the controller 310 determines whether each of the first and second vibration intensities is greater than or equal to a predetermined first threshold th1. The first threshold th1 may be predetermined and may correspond to a reference vibration intensity value by which it can be determined whether the electronic pen 200 touches the first to third display panels 301 to 303.

When each of the first and second vibration intensities is greater than or equal to the first predetermined threshold th1, the controller 310 identifies the second display panel 302 as a position where the electronic pen 200 touches in step 508.

When the first and second vibration intensities are not greater than or equal to the first predetermined threshold th1, the controller 310 determines whether the first vibration intensity is greater than or equal to the first predetermined threshold th1 and the second vibration intensity is less than the first predetermined threshold th1 in step 510. When the first vibration intensity is greater than or equal to the first predetermined threshold th1 and the second vibration intensity is less than the first predetermined threshold th1, the controller 310 identifies the first display panel 301 as the position where the electronic pen 200 touches in step 512.

In step 514, the controller 310 determines whether the first vibration intensity is less than the first predetermined threshold th1 and the second vibration intensity is greater than or equal to the first predetermined threshold th1. When the first vibration intensity is less than the first predetermined threshold th1 and the second vibration intensity is greater than or equal to the first predetermined threshold th1, the controller 310 identifies the third display panel 303 as the position where the electronic pen 200 touches in step 516.

Further, as described above, when the display panel touched by the electronic pen 200 is identified as one of the first to third display panels 301 to 303, the controller 310 calculates a first input position on the identified display panel by using a coordinate value (Nth coordinate value, N=1) received from the electronic pen 200 and the selected display panel in step 518.

Referring to FIG. 5B, the controller 310 determines whether the electronic pen 200 is removed from the display panel in step 520. When the electronic pen 200 is removed from the display panel, the process ends. When the electronic pen 200 is not removed from the display panel, step 522 is performed.

In step 522, the controller 310 increases N by 1 and receives an Nth coordinate value from the electronic pen 200. In step 524, the controller 310 determines whether a value X_{N}−X_{N-1}, generated by subtracting an X value of the previously received coordinate value X_{N-1} from an X value X_{N} of the currently received coordinate value, is greater than or equal to a first predetermined reference value.

The first predetermined reference value can be determined according to a resolution of the display panel. For example, if the first to third display panels 301 to 303 have the resolution of 1080×1920, the predetermined reference value can be 1000 in the display panel having a coordinate value ranging from (0, 0) to (1080, 1920). When each of the first to third display panels 301 to 303 has a coordinate value ranging from (0, 0) to (1080, 1920), the coordinate value rapidly changes from 1080 to 0 as the touch pen 200 moves at a boundary between display panels in a right direction and thus the display panel is switched.

When the value X_{N}−X_{N-1} is greater than or equal to the first predetermined reference value, the controller 310 identifies the display panel on which the electronic pen 200 is located as a right display panel in step 526.

Conversely, when the value X_{N}−X_{N-1} is not greater than or equal to the first predetermined reference value, the controller 310 determines whether the value X_{N}−X_{N-1} is less than or equal to a second predetermined reference value in step 528.

The second predetermined reference value may have a value of, for example, 1000. When each of the first to third display panels 301 to 303 has a coordinate value ranging from (0, 0) to (1080, 1920), the coordinate value rapidly changes from 0 to 1080 as the touch pen 200 moves at a boundary between display panels in a left direction and thus the display panel is switched.

When the value X_{N}−X_{N-1} is less than or equal to the second predetermined reference value, the controller 310 identifies the display panel on which the electronic pen 200 is located as a left display panel in step 530.

Further, the controller 310 calculates an Nth input position on the selected display panel in step 532 and then returns to step 520. The controller 310 repeatedly performs steps 520 to 532 until the electronic pen is removed from the display panel.

According to an operation of the display device 300 as described above, when three display panels are used, the display panel on which the electronic pen 200 is located is distinguished and, therefore, identified. As a result, an accurate position is calculated.

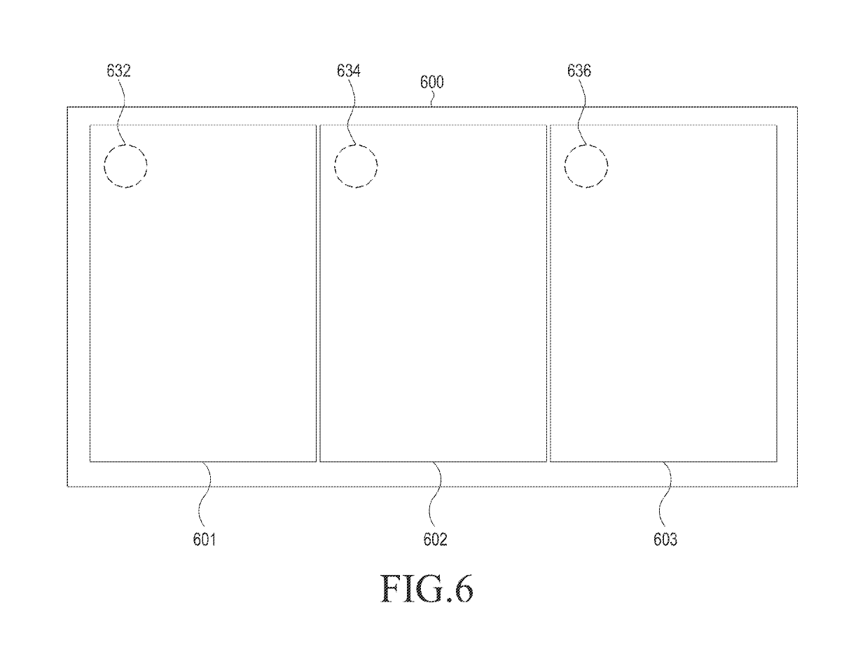

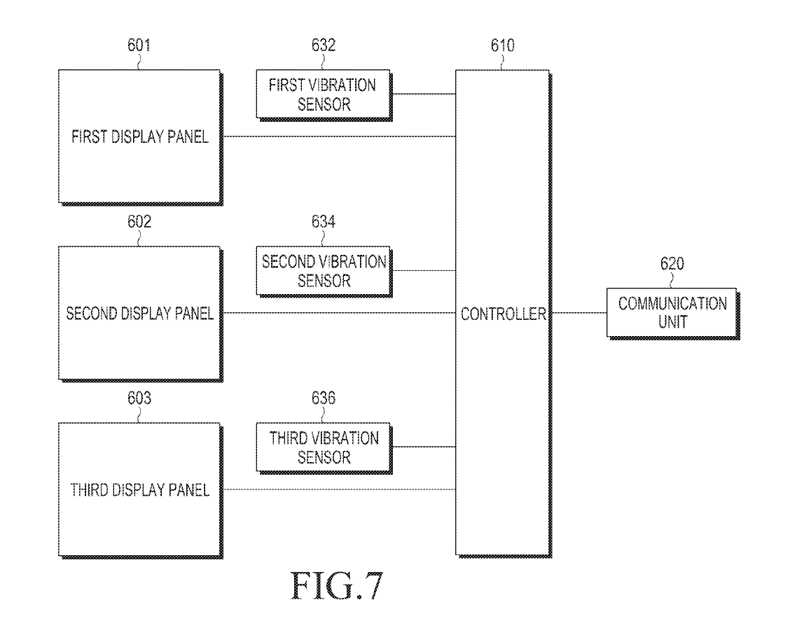

The following is a description of a display device including a plurality of display panels according to the second embodiment of the present invention. FIG. 6 is a diagram illustrating a display device 600 including a plurality of display panels according to the second embodiment of the present invention, and FIG. 7 is a diagram illustrating a configuration of the display device 600.

Referring to FIG. 6, the display device 600 according to the second embodiment of the present invention includes a plurality of display panels formed by connecting three display panels 601, 602, and 603, and vibration sensors 632, 634, and 636 attached to rear surfaces of the three display panels 601, 602, and 603, respectively.

Further, referring to FIG. 7, the display device 600 includes a first display panel 601, a second display panel 602, a third display panel 603, a first vibration sensor 632, a second vibration sensor 634, a third vibration sensor 636, a controller 610, and a communication unit 620.

Each of the first display panel 601, the second display panel 602, and the third display panel 603 includes the pattern shown in FIG. 1, and detects existence or nonexistence of the touch of the electronic pen 200 according to a frequency characteristic generated when the electronic pen 200 touches the display panel and transmits the detection to the controller 610.

The first vibration sensor 632, the second vibration sensor 634, and the third vibration sensor 636 are attached to upper sides of the rear surfaces of the first to third display panels 601 to 603, respectively. The first to third vibration sensors 632 to 636 detect a vibration generated when the electronic pen 200 touches one of the first to third display panels 601 to 603 and transmit detected vibration intensities to the controller 610.

The controller 610 receives a signal corresponding to the existence of the touch of the electronic pen 200 from one of the first to third display panels 601 to 603 and determines the existence of the touch of the electronic pen 200. When the existence of the touch of the electronic pen 200 is determined, the controller 610 selects the display panel which the electronic pen 200 touches from the first to third display panels 601 to 603 according to the vibration intensity received from each of the first to third vibration sensors 632 to 636.

Further, the controller 610 calculates an input position on the selected display panel by using a coordinate value of the electronic pen 200 received by the communication unit 620. In addition, when the input position changes according to a drawing action of the user while the electronic pen 200 touches the display panel, the controller 610 selects the display panel on which the electronic pen 200 is located by using a change in the coordinate value (x coordinate) on a trace along which the electronic pen 200 has been moved.

The communication unit 620 can be implemented by, for example, a ZigBee module, and receives an input position coordinate value from the electronic pen 200. When the electronic pen 200 performs an input by touching or approaching one of the first to third display panels 601 to 603, the electronic pen 200 photographs a pattern formed in the corresponding input position and recognizes the pattern from the photographed pattern image to calculate the corresponding coordinate value. Further, the electronic pen 200 transmits the calculated coordinate value to the display device 600.

The following is a description of an operation of the display device 600 according to the second embodiment of the present invention.

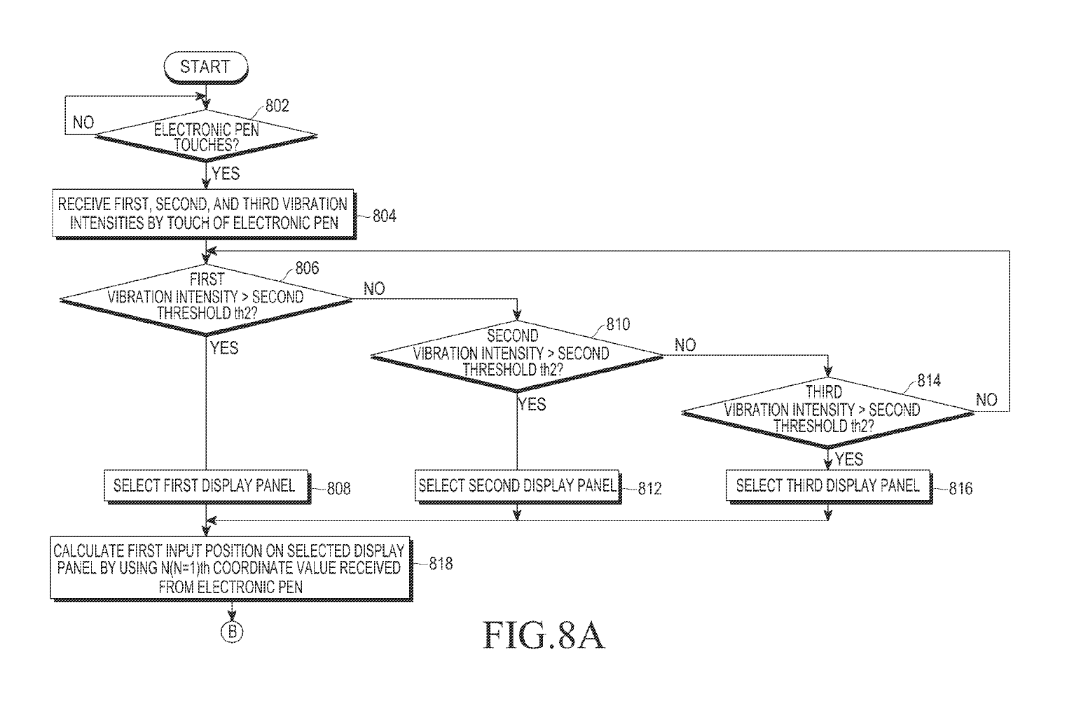

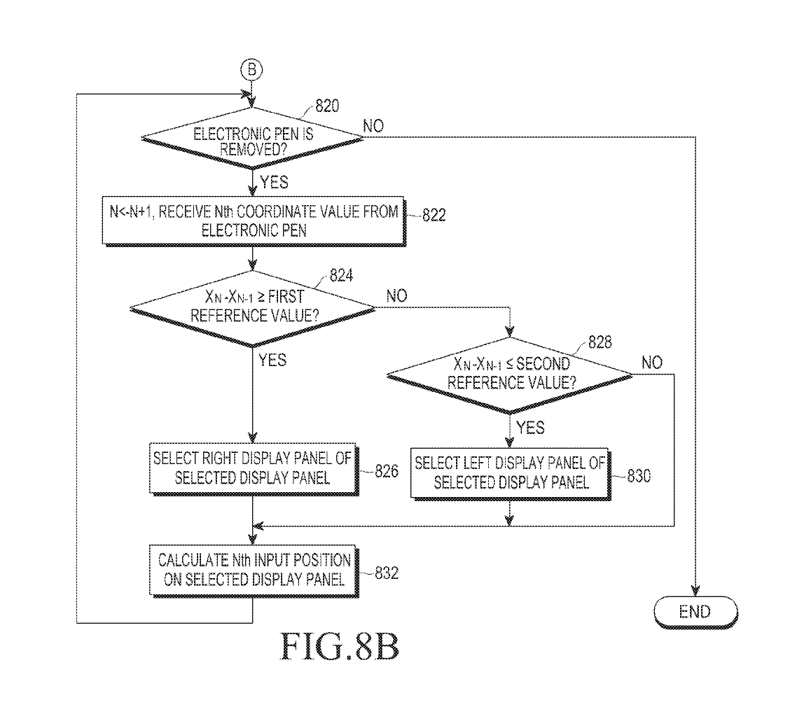

FIGS. 8A and 8B are flowcharts illustrating operations of the display device 600 according to the second embodiment of the present invention. Referring to FIG. 8A, in step 802 first, the controller 610 of the display device 600 determines whether the electronic pen 200 touches the first to third display panels 601 to 603.

Each of the first to third display panels 601 to 603 detects existence of the touch of the electronic pen 200 according to a frequency characteristic generated as the existence of the touch of the electronic pen 200 and transmits a signal corresponding to the detection to the controller 610. The controller 310 receives the signal from the first to third display panels 601 to 603 to determine the existence or nonexistence of the touch of the electronic pen 200. Here, each of the first to third display panels 601 to 603 detects a frequency generated due to a touch of an object, and can detect the existence of the touch of the electronic pen 200 when the measured frequency corresponds to a frequency band corresponding to the touch of the electronic pen 200. Further, when the electronic pen 200 touches the display panel, the frequency band corresponding the touch of the electronic pen 200 can be predetermined by using a characteristic in which an inherent frequency by the electronic pen 200 is generated.

When the electronic pen 200 touches the first to third display panels 601 to 603, the controller 610 receives first, second, and third vibration intensities corresponding to vibrations generated due to the touch of the electronic pen 200 from the first to third vibration sensors 632, 634, and 636 in step 804. The first to third vibration sensors 632, 634, and 636 detect a vibration generated as the electronic pen 200 touches one of the first to third display panels 601 to 603 and transmits first, second, and third vibration intensities of the detected vibration to the controller 610. At this time, when the vibration is not transferred among the first to third display panels 601 to 603, it is possible to identify the display panel touched by the electronic pen 200 by using the first to third vibration intensities measured by the first to third vibration sensors 632, 634, and 636, respectively.

Accordingly, the controller 610 determines whether a first vibration intensity is greater than a second predetermined threshold th2 in step 806. The second predetermined threshold th2 can be predetermined as a reference vibration intensity value by which it can be determined whether the electronic pen 200 touches the first to third display panels 601 to 603. When the first vibration intensity is greater than the second predetermined threshold th2, the controller 610 identifies the first display panel 601 as a position where the electronic pen 200 touches in step 808.

In step 810, when the first vibration intensity is not greater than the second predetermined threshold th2, the controller 610 determines whether a second vibration intensity is greater than the second predetermined threshold th2. When the second vibration intensity is greater than the second predetermined threshold th2, the controller 610 identifies the second display panel 602 as a position where the electronic pen 200 touches in step 812.

In step 814, when the second vibration intensity is not greater than the second predetermined threshold th2, the controller 610 determines whether a third vibration intensity is greater than the second predetermined threshold th2. When the second vibration intensity is greater than the second predetermined threshold th2, the controller 610 identifies the third display panel 603 as a position where the electronic pen 200 touches in step 816.

As described above, when the display panel touched by the electronic pen 200 is identified as one of the first to third display panels 601 to 603, the controller 610 calculates a first input position on the selected display panel by using the coordinate value (Nth coordinate value, N=1) received from the electronic pen 200 and the identified display panel in step 818.

Referring to FIG. 8B, the controller 610 determines whether the electronic pen 200 is removed from the display panel in step 820. When the electronic pen 200 is removed from the display panel, the process ends. When the electronic pen 200 is not removed from the display panel, step 822 is performed.

In step 822, the controller 610 increases an N value by 1 and receives an Nth coordinate value from the electronic pen 200. In step 824, the controller 610 determines whether a value X_{N}−X_{N-1}, generated by subtracting an X value X_{N-1} of the previously received coordinate value from an X value X_{N} of the currently received coordinate value, is greater than or equal to a first predetermined reference value.

The first predetermined reference value may be determined according to a resolution of the display panel. For example, if the first to third display panels 601 to 603 have a resolution of 1080×1920, the first predetermined reference value may have a value of, for example, 1000 in the display panel having a coordinate value ranging from (0, 0) to (1080, 1920). When each of the first to third display panels 601 to 603 has a coordinate value ranging from (0, 0) to (1080, 1920), the coordinate value rapidly changes from 1080 to 0 as the touch pen 200 moves at a boundary between display panels in a right direction and thus the display panel is switched.

When the value X_{N}−X_{N-1} is greater than or equal to the first predetermined reference value, the controller 610 identifies the display panel on which the electronic pen 200 is located as a right display panel in step 826.

In step 828, when the value X_{N}−X_{N-1} is not greater than or equal to the first predetermined reference value, the controller 610 determines whether the value X_{N}−X_{N-1} is less than or equal to a second predetermined reference value.

The second predetermined reference value may have a value of, for example, 1000. When each of the first to third display panels 601 to 603 has a coordinate value ranging from (0, 0) to (1080, 1920), the coordinate value rapidly changes from 0 to 1080 as the touch pen 200 moves at a boundary between display panels in a left direction and thus the display panel is switched.

When the value X_{N}−X_{N-1} is less than or equal to the second predetermined reference value, the controller 610 identifies the display panel on which the electronic pen 200 is located as a left display panel in step 830.

Further, the controller 610 calculates an Nth input position on the selected display panel in step 832 and then returns to step 820. The controller 610 repeatedly performs steps 520 to 532 until the electronic pen is removed from the display panel.

According to an operation of the display device 600 including the plurality of display panels according to the second embodiment of the present invention as described above, when three display panels are used, the display panel on which the electronic pen 200 is located can be selected by using the three vibration sensors attached to the display panels and thus an accurate position of the electronic pen 200 can be calculated.

According to various embodiments of the present invention, the display panel into which the input by the electronic pen is detected can be identified through the vibration intensity, so that the input position detection using pattern recognition can be applied even when the plurality of display panels are used.

Further, according to various embodiments of the present invention, when a position of the input by the drawing action of the electronic pen moves from a first display panel to a second display panel, the changed display panel can be identified, so that the position detection using pattern recognition can be applied even when the plurality of display panels are used.

In addition, according to various embodiments of the present invention, the display panel on which the input is performed through the electronic pen can be distinguished by using a cheap vibration sensor and a simple algorithm, so that the implementation of the display device including the multiple display panels is feasible and economical.

Although the embodiments of the present invention have been discussed in the above detailed description, various modifications can be made without departing from the scope of the present invention. For example, the present invention has described the case in which there are three display panels. However, the number of display panels is not limited to such and one or more display panels may be used in the present invention. Further, the embodiments of the present invention have described the case where there are two to three vibration sensors. However, the number of vibration sensors may vary as long as the vibration sensors can distinguish the display panel touched by the electronic pen. Accordingly, the scope of the present invention is not limited to the disclosed embodiments, but should be defined by the equivalents to the appended claims.

In summary, the foregoing description provides embodiments of the present invention and is not used for limiting the protection scope thereof. Any modification, equivalent substitution, or improvement made without departing from the spirit and principle of the present invention should be covered by the protection scope of the following claims of the present invention.

What is claimed is:

1. A display device, comprising:
a plurality of display panels;
one or more vibration sensors for detecting a vibration corresponding to a touch of an input device, the vibration sensors being attached to the plurality of display panels; and
a controller for identifying, when one of the plurality of display panels is touched by the input device, the display panel touched by the input device from the plurality of display panels according to vibration intensities detected by the one or more vibrations sensors.

2. The display device of claim 1, further comprising a communication unit for receiving, from the input device, a coordinate value calculated according to recognition of a pattern in an area touched by the input device.

3. The display device of claim 2, wherein the controller calculates an input position of the input device by using the coordinate value from the input device and the selected display panel.

4. The display device of claim 3, wherein, when the coordinate value from the input device changes, the controller identifies a display panel on which the input device is located by using a change in the coordinate value.

5. The display device of claim 1, wherein the plurality of display panels are formed by connecting three display panels, and the one or more vibration sensors include two vibration sensors which are attached to a rear surface of a center display panel of the three display panels.

6. The display device of claim 1, wherein the plurality of display panels are formed by connecting three display panels, and the one or more vibration sensors include three vibration sensors which are attached to rear surfaces of the three display panels, respectively.

7. A display method using a plurality of display panels, the display method comprising:
detecting whether an input device touches one of the plurality of display panels;
receiving vibration intensities detected by one or more vibration sensors when the input device touches one of the plurality of display panels; and
identifying the display panel touched by the input device from the plurality of display panels according to the received vibration intensities.

8. The display method of claim 7, further comprising receiving, from the input device, a coordinate value calculated according to recognition of a pattern in an area touched by the input device.

9. The display method of claim 8, further comprising calculating an input position of the input device by using the coordinate value received from the input device and the selected display panel.

10. The display method of claim 9, further comprising, when the coordinate value from the input device changes, identifying a display panel on which the input device is located by using a change in the coordinate value.
